(19) United States
(12) Patent Application Publication
(10) Pub. No.: US 2022/0292854 A1
(43) Pub. Date: Sep. 15, 2022

(54) MINIATURE MICROSCOPIC CELL IMAGE ACQUISITION DEVICE AND IMAGE RECOGNITION METHOD

(71) Applicant: WUHAN LANDING MEDICAL HIGH-TECH CO., LTD., Wuhan city, Hubel Province (CN)

(72) Inventors: Baochuan PANG, Wuhan city, Hubei Province (CN); Qiang LUO, Wuhan city, Hubei Province (CN); Xiaorong SUN, Wuhan city, Hubei Province (CN); Jian WANG, Wuhan city, Hubei Province (CN); Dehua CAO, Wuhan city, Hubei Province (CN)

(73) Assignee: WUHAN LANDING MEDICAL HIGH-TECH CO., LTD., Wuhan city, Hubei Province (CN)

(21) Appl. No.: 16/635,999

(22) PCT Filed: Dec. 25, 2019
(86) PCT No.: PCT/CN2019/128221

§ 371 Date: Jan. 31, 2020

(30) Foreign Application Priority Data
Nov. 14, 2019 (CN) 201911113561.1

(51) Int. Cl. G06V 20/69; G06T 7/155; G06T 7/11; G06V 10/77; G06V 10/26; G06V 10/94; H04M 1/02; G02B 21/36; G02B 21/00

(52) U.S. Cl. CPC G06V 20/695; G06V 20/698; G06V 20/693; G06T 7/155; G06T 7/11; G06V 10/7715; G06V 10/26; G06V 10/95; H04M 1/0264; G02B 21/362; G02B 21/0036; G02B 21/367; H04M 2250/52

(57) ABSTRACT

A miniature microscopic cell image acquisition device and an image recognition method are provided. The miniature microscopic cell image acquisition device comprises a support, wherein a movable module platform is provided on the support, and a camera module is provided on the module platform. A microscope head that is relatively fixed is provided below a camera of the camera module, a slide holder is provided below the microscope head, and a lighting source is provided below the slide holder. A scanning drive module is provided between the slide holder and the camera module to perform a scanning movement along X and Y axes, so that the slide holder and the camera module make a scanning movement along the X and Y axes, and images of a slide are acquired by the camera module in a scanning manner.

### FIELD

The present invention relates to the field of medical image acquisition, more particularly, to a miniature microscopic cell image acquisition device, and image stitching, recognition and cloud processing methods.

### BACKGROUND

Cell and tissue section scanning is of important materials for disease diagnosis, scientific research, and teaching. A tissue section in a slide is scanned with a digital tissue section scanner and converted into a digital image for the sake of easy storage, transmission and remote diagnosis. However, the existing digital tissue section scanners are very expensive, about 500,000 Yuan each, for example, in the scheme described in Chinese patent document CN 107543792 A, which limits the popularization of diagnosis, scientific research and teaching methods for tissue sections. In order to solve this technical problem, some improved schemes are also adopted in the prior art to reduce equipment costs. The Chinese patent document CN 106226897 A describes a tissue section scanning device based on a common optical microscope and a smart phone, which is composed of a microscope holder, a common optical microscope, a smart phone, a focusing and section moving device, a smart phone holder and a computer. The functions of the smartphone, the computer, and the microscope are integrated to digitize tissue sections in a low-cost and convenient way. However, this structure is still large in volume, and thus inconvenient to move, and the price is still high. In addition, the optical path is relatively long, which affects the acquisition accuracy of patterns.

### SUMMARY

The technical problem to be solved by the present invention is to provide a miniature microscopic cell image acquisition device, and image stitching and recognition methods, which can greatly reduce the cost and the volume, and can realize automatic scanning and acquisition, as well as stitching and recognition and cloud processing of graphics.

To solve the above technical problems, the technical solution adopted by the present invention is as follows: a miniature microscopic cell image acquisition device comprises a support, wherein a movable module platform is provided on the support, and a camera module is provided on the module platform; a microscope head that is relatively fixed is provided below a camera of the camera module, a slide holder is provided below the microscope head, and a lighting source is provided below the slide holder; and a scanning drive module is provided between the slide holder and the camera module to perform a scanning movement along X and Y axes, so that the slide holder and the camera module make a scanning movement along the X and Y axes, and images of the glass slide are acquired by the camera module in a scanning manner.

In a preferred solution, the microscope head comprises a cantilever rod mounted on the module platform, wherein one end of the cantilever rod is fixedly connected to the module platform, and a microscope lens is provided on the other end of the cantilever rod; the microphone lens is located below the camera; and the magnification of the microscope lens is 2 to 10 times.

In a preferred solution, the module platform is provided with a sunken stage near the camera, and the cantilever rod is slidably connected to the stage through a plurality of positioning screws; an adjusting screw is in threaded connection with the cantilever rod; the tip of the adjusting screw props against the stage; a distance between the cantilever rod and the stage is adjusted by the rotation of the adjusting screw; and the microscope lens is a replaceable microscope lens.

In a preferred solution, the miniature microscopic cell image acquisition device further comprises a control box, wherein a main control chip is provided in the control box and electrically connected with the camera; the main control chip is further electrically connected with a control button and/or a touch screen of the camera module; the main control chip is further electrically connected with a drive motor of a scanning drive module; and the camera adopts a mobile phone camera accessory.

In a preferred solution, the module platform is connected to the scanning drive module, such that the camera makes a scanning movement along the X and Y axes; the slide holder and the support are fixedly connected and kept stationary; the scanning drive module is structurally characterized in that: an X-axis guide rail is fixedly provided on the support, and an X-axis slider is slidably mounted on the X-axis guide rail; an X-axis nut is fixedly provided on the X-axis slider; an X-axis screw rod is rotatably mounted on the support; an X-axis nut is in threaded connection with the X-axis screw rod; an X-axis drive motor is fixedly provided on the support; an output shaft of the X-axis drive motor is fixedly connected to the X-axis screw rod, so that the X-axis drive motor drives the X-axis slider to reciprocate along the X-axis guide rail; a Y-axis guide rail is fixedly provided on the X-axis slider, and the module platform is slidably mounted on the Y-axis guide rail; a Y-axis nut is fixedly provided on the module platform; a Y-axis screw rod is rotatably mounted on the X-axis slider; a Y-axis nut is in threaded connection with the Y-axis screw rod; a Y-axis drive motor is fixedly provided on the X-axis slider; an output shaft of the Y-axis drive motor is fixedly connected to the Y-axis screw rod, so that the Y-axis drive motor drives the module platform to reciprocate along the Y-axis guide rail; the miniature microscopic cell image acquisition device is further provided with a control box, wherein the control box outputs a switch signal to be connected to the camera module to control the camera module to acquire images; and the control box outputs pulse signals to be connected to the Y-axis drive motor and the X-axis drive motor, respectively, to drive the X-axis drive motor and the Y-axis drive motor to rotate respectively.

In a preferred solution, the module platform and the support are fixedly connected and kept stationary; the slide holder is connected to the scanning drive module, so that the slide holder makes a scanning movement along the X and Y axes; the scanning drive module is structurally characterized in that: the X-axis drive motor is fixedly connected to the support; a sliding rail in an X-axis direction is provided on the support; a sliding platform is slidably mounted on the slide rail in the X-axis direction; the X-axis drive motor is connected to the sliding platform through a screw and nut mechanism so as to drive the sliding platform to reciprocally slide in the X-axis direction; the Y-axis drive motor and a sliding rail in a Y-axis direction are fixedly provided on the sliding platform; the slide holder is slidably mounted on the sliding rail in the Y-axis direction; the Y-axis drive motor is connected to the slide holder through a screw and nut mechanism so as to drive the slide holder to reciprocally slide in the Y-axis direction; the miniature microscopic cell image acquisition device is further provided with a control box, wherein the control box outputs a switch signal to be connected to the camera module to control the camera module to acquire images; and the control box outputs pulse signals to be connected to the Y-axis drive motor and the X-axis drive motor, respectively, to drive the X-axis drive motor and the Y-axis drive motor to rotate respectively.

In a preferred solution, the X-axis drive motor and the Y-axis drive motor are stepping motors; and a storage chip, an interface chip and a wireless transmission chip are further provided in the control box, and are all electrically connected with the main control chip; the storage chip is configured to store data, and the interface chip and the wireless transmission chip are configured to transmit data; and the control box is provided with a power chip configured to supply power to the main control chip, the storage chip, the interface chip and the wireless transmission chip.

An image stitching method adopting the miniature microscopic cell image acquisition device is provided, wherein a visual field sub-block matching module, a visual field position fitting module, and a block extraction module are included, wherein, the visual field sub-block matching module is configured to identify an overlapping area between every two adjacent images and determine an adjacent positional relationship between the sub-images, so that the sub-images acquired by a microscopic scanning device are automatically arranged in a stitching order of the images; the visual field position fitting module is configured to finely tune positions according to the overlapping area between every two adjacent sub-images, so that cell positions are accurately stitched; the block extraction module is configured to automatically extract a completely stitched image; and the specific implementation steps are as follows:

S1: visual field sub-block matching: the visual field sub-block matching module is configured to identify an overlapping region between every two adjacent images and determine an adjacent positional relationship between the sub-images, so that the sub-images acquired by the microscopic scanning device are automatically arranged in a stitching order of the images;

S2: visual field position fitting: the visual field position fitting module is configured to finely tune positions according to the overlapping region between every two adjacent sub-images, so that cell positions are accurately stitched;

S3: block extraction: the block extraction module is configured to automatically extract a completely stitched image;

the operating process of the visual field sub-block matching in step S1 is as follows:

Sa01: inputting and initiating a result set M;

Sa02: setting the current visual field i as a first visual field;

Sa03: solving a set J of all adjacent visual fields of the current visual field i;

Sa04: setting the current adjacent visual field j as a first visual field in J;

Sa05: solving possible overlapping regions Ri and Rj of the visual field i and the visual field j;

Sa06: rasterizing a template region Ri into template sub-block sets Pi;

Sa07: sorting the template sub-block sets Pi in a descending order according to a dynamic range of the sub-blocks;

Sa08: setting the current template sub-block P as the first one in the template sub-block sets Pi;

Sa09: solving a possible overlapping region s of the template sub-block P in the visual field J;

Sa10: performing a template matching search by taking the template sub-block P as a template and s as a search region;

Sa11: adding a best match m to the result set M;

Sa12: finding all matching visual field sets N that are in consistent with m from the result set M;

Sa 13: judging whether or not a weight in N is greater than a threshold v upon comparison;

if not, setting the current template sub-block P as the next one in the template sub-block sets Pi and returning to Sa09;

if yes, proceeding to next step;

Sa14: judging whether or not the visual field j is the last visual field in the visual field set J upon comparison;

if not, setting the visual field j as the next visual field in the visual field set J and returning to Sa05;

if yes, proceeding to next step;

Sa15: judging whether or not the visual field i is the last visual field upon comparison;

if not, setting i as the next visual field and returning to Sa03;

if yes, outputting a result;

the process of visual field position fitting in step S2 is as follows:

Sa16: inputting and initializing all visual field positions Xi, Yi;

Sa17: setting the current visual field i as a first visual field;

Sa18: obtaining a matching subset Mi including the visual field i from the sub-block matching set M;

Sa19: recalculating the positions Xi and Yi of the visual field i according to the matching subset Mi;

Sa20: judging whether or not all visual field updates are completed;

if not, setting the visual field i as the next visual field;

if yes, proceeding to next step;

Sa21: calculating an average deviation L between the current visual field position and the previous visual field position;

Sa22: judging whether or not the average deviation L is less than a threshold value 1 upon comparison;

if not, returning to Sal 17;

if yes, proceeding to next step;

Sa23: performing normalized adjustment on the visual field positions;

outputting all the visual fields;

the process of block extraction in step S3 is as follows:

Sa24: extracting sizes W, H of a full graph;

Sa25: dividing the full graph into a set B of blocks according to the block sizes;

Sa26: calculating the positions of all blocks b in the set B;

Sa27: setting one of the blocks b as the first block in the set B;

Sa28: calculating a set Fb of all visual fields overlapping with the block b;

Sa29: setting a visual field f as the first visual field in Fb;

Sa30: solving the overlapping regions Rb and Rf of the visual field f and the block b;

Sa31: copying an image in Rf to Rb;

Sa32: judging whether or not the visual field f is the last visual field in the set Fb;

if not, setting the visual field f as the next visual field in Fb and returning to Sa29;

if yes, proceeding to next step;

Sa33: saving an image of the block b;

Sa34: judging whether or not the block b is the last block in the set B;

if not, setting the block b as a first block in the set B and returning to Sa28; and

if yes, outputting a result.

An image recognition method adopting the miniature microscopic cell image acquisition device comprises the following implementation steps:

S1: acquiring microscopic images;

S2: stitching a plurality of images of a single sample, and extracting according to cell nucleus features in the stitched image to obtain microscopic images of single cell nucleus;

S3: classifying the microscopic images of single cell nucleus according to the labeled cells by means of an artificial intelligence program subjected to model training;

thereby obtaining sample-based classified cell data through the above steps;

the step of acquiring the microscopic image of single cell nucleus in step S2 is as follows:

S100: detecting features points of the cell nucleus:

reducing each image to a plurality of different scales and extracting feature points respectively;

S101: performing preliminary screening, i.e., screening to remove feature points that are too close by using coordinates of the feature points, thereby reducing repeated extraction of cells;

S102: subdividing and segmenting according to a color difference threshold: converting a picture to a LAB format; and after the inversion of a B channel as well as the weighting and Otsu thresholding of an A channel, segmenting to obtain a cell nucleus mask map, wherein the weight is 0.7 for the B channel under the inversion and 0.3 for the A channel;

S103: performing image morphology operation:

a combination of one or more of corrosion operation and expansion operation; and

S104; performing fine screening according to a nuclear occupancy parameter to remove non-cells each having a nuclear occupancy ratio below 0.3 and a nucleus radius above 150 pixels and below 10 pixels, wherein the nuclear occupancy ratio is obtained by dividing a nuclear area finely segmented according to the color difference threshold by a radius circle area of the detected feature point.

A method for cloud processing of an image, that adopts the miniature microscopic cell image acquisition device comprises the following implementation steps:

S1: numbering: numbering samples on the slide to determine sample numbers in a cloud system;

S2: registration: entering subject information corresponding to the slide into the system and entering the sample numbers;

scanning: scanning images of the slide with the camera module;

S3: uploading: uploading the scanned image samples to the cloud system;

S4: stitching classification: processing the digital samples on cloud AI;

S5: connection: associating the registration information with the digitalized sample information in the system;

S6: diagnosis: diagnosing and reviewing the image samples, and submitting a diagnosis opinion operation by a doctor;

S7: report rendering: polling the completely diagnosed data in the system by using a rendering program and rendering the data into PDF, JPG, WORD format files according to corresponding report templates thereof;

thereby achieving cloud processing of the images through the above steps.

The miniature microscopic cell image acquisition device provided by the present invention can greatly reduce the price of digital tissue section scanners in the prior art, and greatly reduce the medical cost. By adopting the structure of the microscope head having a cantilever structure, the volume can be greatly reduced, thereby being convenient to carry and promote. Preferably, by using the accessories of the mobile phone camera, high-resolution and inexpensive accessories can be obtained in a large-scale production scale. A mobile phone main control chip without some baseband function modules can be used as the main control chip of the present invention, such that the overall cost can be reduced on the premise of reducing the license fee. The present invention provides an image stitching method adopting the miniature microscopic cell image acquisition device, which realizes the partition scanning and combination of images, improves the speed of image scanning, and ensures the integrity of the slide samples. The present invention further provides an image recognition method adopting the miniature microscopic cell image acquisition device, which greatly improves the accuracy and efficiency of cell recognition. The present invention may further provides a method for cloud processing of an image, that adopts the miniature microscopic cell image acquisition device, where the scanned slide samples are transmitted to the cloud, and are stitched and recognized on the cloud to achieve long-distance AI diagnosis and doctors' re-examination, which not only improves the detection efficiency, but also reduces the requirements of sample detection for regions. In addition, the original sample data of detection can be retained, and the data are further researched, so that more remote medical institutions can also apply such technology for diagnosis.

### BRIEF DESCRIPTION OF THE DRAWINGS

The present invention is further described below with reference to the drawings and the embodiments.

FIG. 1 is a stereoscopic structural schematic diagram of the present invention.

FIG. 2 is a locally schematic top view of the present invention.

FIG. 3 is a front sectional view of the present invention.

FIG. 4 is a schematic top view of another preferred embodiment of the present invention.

FIG. 5 is a stereoscopic schematic diagram of yet another preferred embodiment of the present invention.

FIG. 6 is a structural schematic diagram of a microscope head in the present invention.

FIG. 7 is a control structural diagram of a control box in the present invention.

FIG. 8 is a control structure block diagram in the present invention.

FIG. 9 is a schematic diagram showing processing of a picture matched with a visual field sub-block after a slide is scanned in the present invention.

FIG. 10 is a schematic diagram after the scanned images are stitched in the present invention.

FIG. 11 is a schematic flowchart showing an image stitching process in the present invention.

FIG. 12 is a schematic flowchart showing visual field sub-block matching in the present invention.

FIG. 13 is a schematic flowchart showing visual field position fitting in the present invention.

FIG. 14 is a schematic flowchart showing block extraction in the present invention.

FIG. 15 is an exemplary diagram after image recognition in the present invention.

FIG. 16 is an exemplary diagram of a cell classification process in the present invention.

FIG. 17 is a morphology diagram of a single cell nucleus obtained by the present invention and capable of characterizing user's cytopathology.

FIG. 18 is a schematic diagram showing a process for acquiring microscopic images of single cell nucleus in the present invention.

FIG. 19 is a flowchart of an image recognition method in the present invention.

FIG. 20 is a flowchart of a method for cloud processing of an image in the present invention.

In the drawings, the reference symbols represent the following components: camera module 1, camera 111, control button 112, touch screen 113, module platform 2, stage 21, positioning pin 22, adjusting screw 23, microscope head 3, replaceable microscope plate 31, cantilever rod 32, support 4, slide holder 5, first slide stop 51, second slide stop 52, Y-axis drive motor 6, Y-axis screw rod 61, Y-axis slide rail 62, Y-axis nut 63, X-axis slider 64 , slide 7, lighting source 8, control box 9, main control chip 91, storage chip 92, interface chip 93, power chip 94, wireless transmission chip 95, X-axis drive motor 10, X-axis screw rod 101, X-axis slide rail 102, X-axis nut 103, and sliding platform 104.

### DETAILED DESCRIPTION

### Embodiment 1

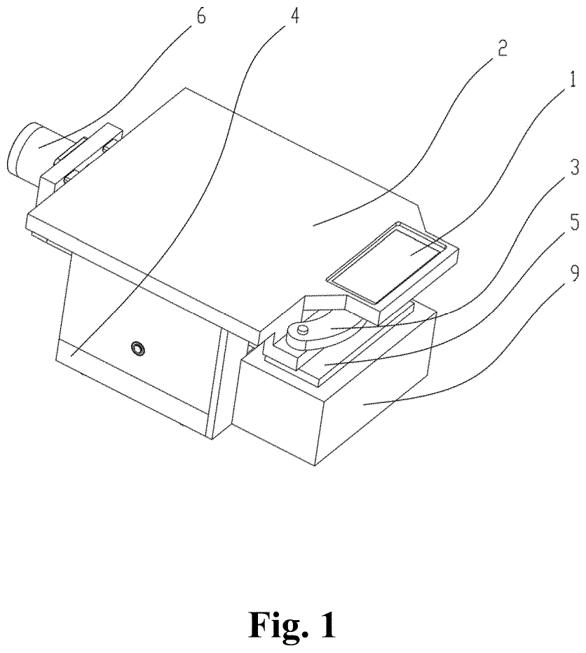

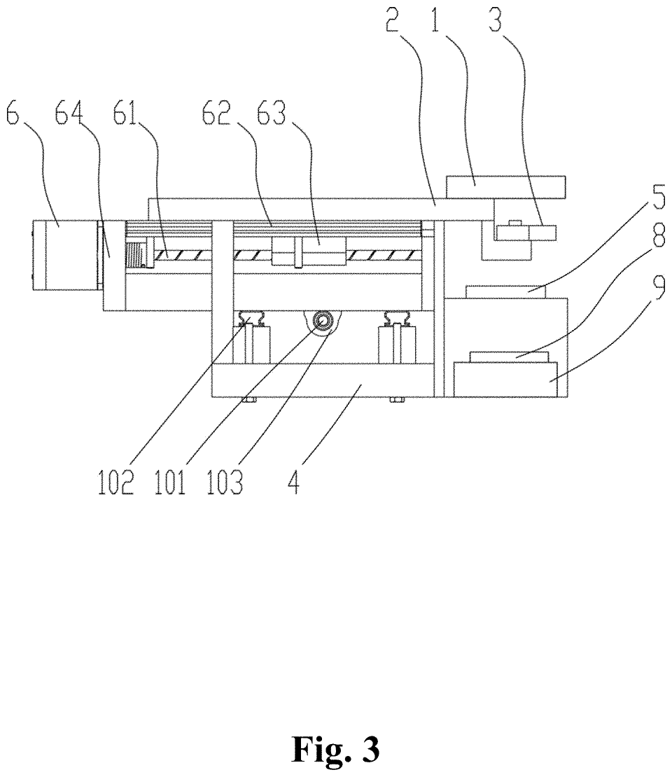

As shown in FIGS. 1 to 8, a miniature microscopic cell image acquisition device comprises a support 4, wherein a movable module platform 2 is provided on the support 4, and a camera module 1 is provided on the module platform 2.

A microscope head 3 that is relatively fixed is provided below a camera 111 of the camera module 1, a slide holder 5 is provided below the microscope head 3, and a lighting source 8 is provided below the slide holder 5. When in use, light of the lighting source passes through a slide on the slide holder, and images of cells are transmitted to the camera 111 through the microscope head, so as to be acquired and stored by the camera 111.

A scanning drive module is provided between the slide holder 5 and the camera module 1 to perform a scanning movement along X and Y axes, so that the slide holder 5 and the camera module 1 make a scanning movement along the X and Y axes, and the images of the glass slide 7 are acquired by the camera module 1 in a scanning manner. With this structure, the images of the slide 7 are acquired into the camera 111. Preferably, the camera 111 is a mobile phone camera accessory, for example: a camera module from O-film Technology Co., LTD, SUNNY Optical Technology (Group) Co., LTD, Q Technology (Group) Company Limited or the like.

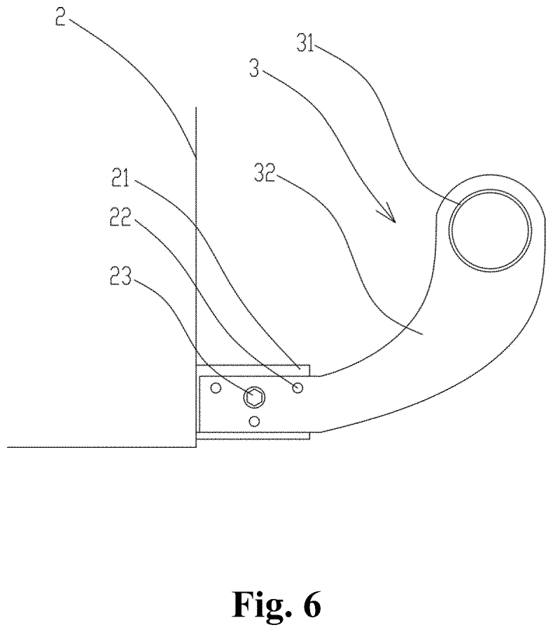

In a preferred solution, as shown in FIGS. 1 and 6, the microscope head 3 includes a cantilever rod 32 mounted on the module platform 2. One end of the cantilever rod 32 is fixedly connected to the module platform 2, and a microscope lens is provided on the other end of the cantilever rod 32. The microscope lens is located below the microscope lens. The magnification of the microscope lens is 2 to 10 times. Further preferably, the magnification of the microscope lens is 4 times. The microscope lens 11 is located below the camera 111. In the present invention, a complicated optical path structure of a microscope in the prior art is replaced with a microscope head 3, thereby further reducing the cost and the volume, and further improving the sharpness of an image.

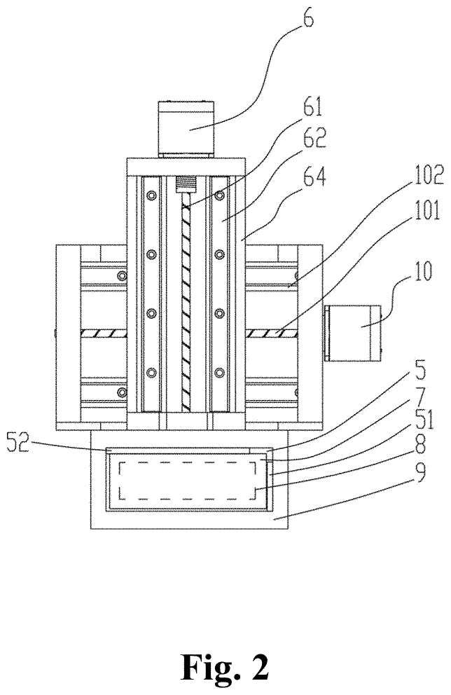

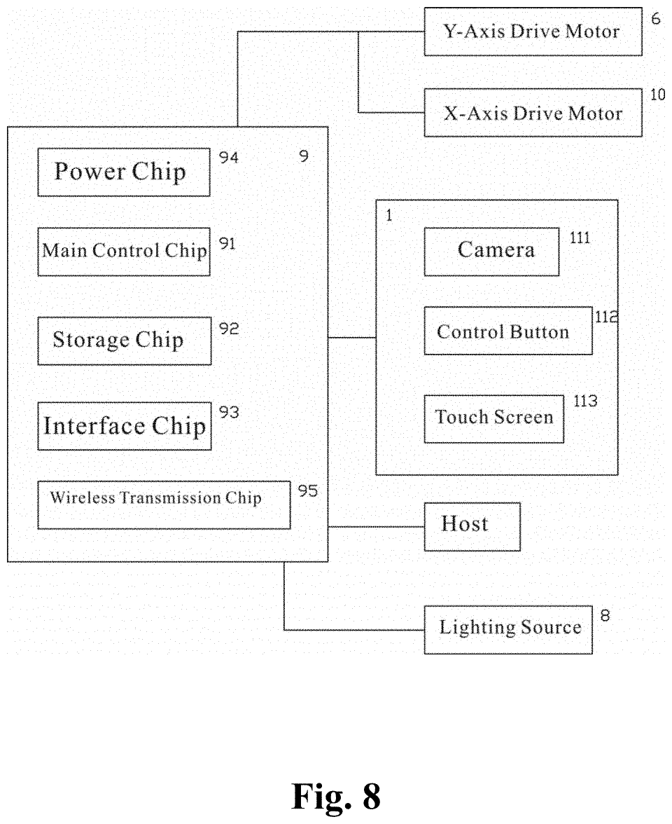

In a preferred solution, as shown in FIGS. 2 and 8, the module platform 2 is provided with a sunken stage 21 near the camera 111, and the cantilever rod 32 is fixedly connected to the stage 21 through a screw 107. With this structure, the microscope head 3 is mounted and connected conveniently.

In a preferred solution, as shown in FIG. 6, the module platform 2 is provided with a sunken stage 21 near the camera 111, and the cantilever rod 32 is slidably connected to the stage 21 through a plurality of positioning screws 22. An adjusting screw 23 is in threaded connection with the cantilever rod 32. The tip of the adjusting screw 23 props against the stage 21. A distance between the cantilever rod 32 and the stage 21 is adjusted by the rotation of the adjusting screw 23. Further preferably, a further fixing screw is further provided to pass through the cantilever rod 32 and to be in threaded connection with the sunken stage 108. After adjusting to a proper position, the further screw is tightened.

The microscope lens is a replaceable microscope lens 31. The replaceable microscope lens 31 is of a structure in movable socketing with the cantilever rod 32, thereby facilitating the adjustment of the magnification by replacing the microscope lens.

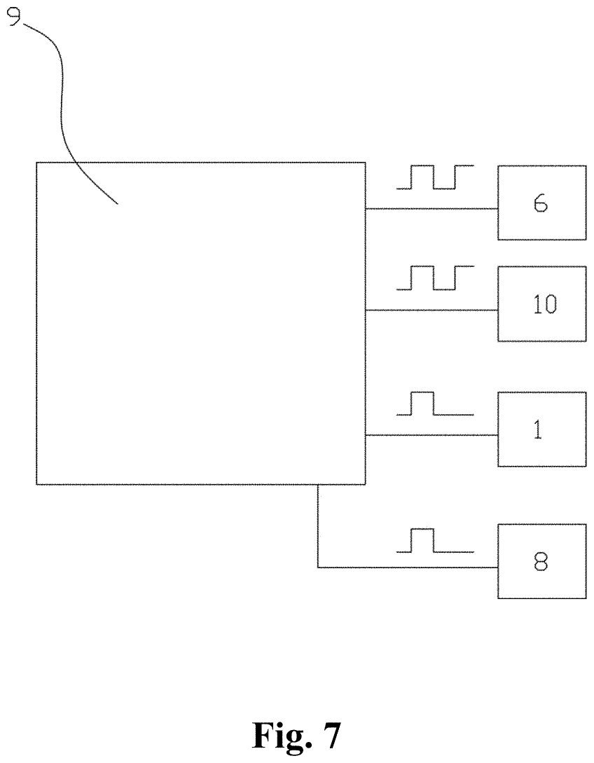

In a preferred solution, as shown in FIGS. 7 and 8, the miniature microscopic cell image acquisition device further comprises a control box 9, wherein a main control chip 91 is provided in the control box 9. A Qualcomm SOC system integrated chip for a mobile phone is preferably adopted as the main control chip 91, which already includes a CPU, a GPU, a DSP digital signal processing module, a Bluetooth module and a WiFi module, and a Power

Management power management module, or SOC from MediaTek, Samsung, or Huawei. Further preferably, a simplified SOC is selected, for example, the SOC from which a baseband module is canceled, to reduce the corresponding authorization fee and further reduce the cost. Further preferably, a dual-chip mode is adopted, or an AI acceleration chip is integrated in the chip, and used to perform image calculations, intelligent classification, recognition and other operations in subsequent steps to further improve the processing speed.

The main control chip 91 is electrically connected with the camera 111. The main control chip 91 is further electrically connected with a control button 112 and/or a touch screen 113 of the camera module 1. The control button 112 and/or the touch screen 113 are used to start a scanning program or to control individual shooting. The touch screen 113 is also configured to set parameters such as a scanning mode, a resolution, an image format, and an intelligent recognition model. The main control chip 91 is further electrically connected with a drive motor of a scanning drive module.

In a preferred solution, the module platform 2 is connected to the scanning drive module, such that the camera 111 makes a scanning movement along the X and Y axes.

The slide holder 5 and the support 4 are fixedly connected and kept stationary.

The scanning drive module is structurally characterized in that:

an X-axis guide rail 102 is fixedly provided on the support 4, and an X-axis slider 64 is slidably mounted on the X-axis guide rail 102; an X-axis nut 103 is fixedly provided on the X-axis slider 64; an X-axis screw rod 101 is rotatably mounted on the support 4; an X-axis nut 103 is in threaded connection with the X-axis screw rod 101; an X-axis drive motor 10 is fixedly provided on the support 4; an output shaft of the X-axis drive motor 10 is fixedly connected to the X-axis screw rod 101, so that the X-axis drive motor 10 drives the X-axis slider 64 to reciprocate along the X-axis guide rail 102;

a Y-axis guide rail 62 is fixedly provided on the X-axis slider 64, and the module platform 2 is slidably installed on the Y-axis guide rail 62; a Y-axis nut 63 is fixedly provided on the module platform 2; a Y-axis screw rod 61 is rotatably mounted on the X-axis slider 64; a Y-axis nut 63 is in threaded connection with the Y-axis screw rod 61; a Y-axis drive motor 6 is fixedly provided on the X-axis slider 64; an output shaft of the Y-axis drive motor 6 is fixedly connected to the Y-axis screw rod 61, so that the Y-axis drive motor 6 drives the module platform 2 to reciprocate along the Y-axis guide rail 62. With the above structure, the camera 111 makes a serpentine scanning operation. With the above structure, the module platform 2 makes a serpentine scanning movement along the X and Y axes. It should be noted that the movements along the X axis and along the Y axis can be interchanged. In this embodiment, the drive mechanism along the X axis is located below the drive mechanism along the Y axis, and it is an equivalent interchangeable structure that the drive mechanism along the Y axis is located below the drive mechanism along the X axis. In an optional solution, the module platform 2 is fixedly connected with the support 4. However, it is equivalent interchangeable structure that the slide holder 5 is movably connected with the support 4 through the scanning drive module so as to achieve a serpentine scanning operation of the slide holder 5.

The miniature microscopic cell image acquisition device is further provided with a control box 9, wherein the control box 9 outputs a switch signal to be connected to the camera module 1 to control the camera module 1 to acquire images; and

the control box 9 outputs pulse signals to be connected to the Y-axis drive motor 6 and the X-axis drive motor 10, respectively, to drive the X-axis drive motor 10 and the Y-axis drive motor 6 to rotate respectively.

In a preferred solution, the Y-axis drive motor 6 and the X-axis drive motor 10 are stepping motors.

A storage chip 92, an interface chip 93 and a wireless transmission chip 95 are further provided in the control box 9, and are all electrically connected with the main control chip 91.

The storage chip 92 is configured to store data. The storage chip includes an on-chip SRAM static memory, an off-chip DRAM dynamic memory, and a flash-based SSD or SD chip. The interface chip 93 and the wireless transmission chip 95 are configured to transmit data. The interface chip 93 includes a bus chip and a USB chip. The bus chip provides a bus-level interface, and a high-speed bus interface, such as a PCIe bus is preferably adopted. The USB chip is configured to transmit input parameters and control signals of a control button 112. The wireless transmission chip 95 includes a Bluetooth chip and a WiFi chip.

The control box is provided with a power chip 94 configured to supply power to the main control chip 91, the storage chip 92, the interface chip 93 and the wireless transmission chip 95, for example, a power management unit PMU. Further preferably, a mobile phone chip without being integrated with a baseband module and a radio frequency module is used to further reduce the use cost. Further preferably, a multi-chip scheme is adopted to improve the image processing speed. For example, a two-chip processing scheme is adopted, one of which is used as a main control chip and the other is used as an image operation chip, thereby realizing continuous slide scanning and fully-automatic stitching and recognition processing, and uploading the processed results to the cloud.

### Embodiment 2

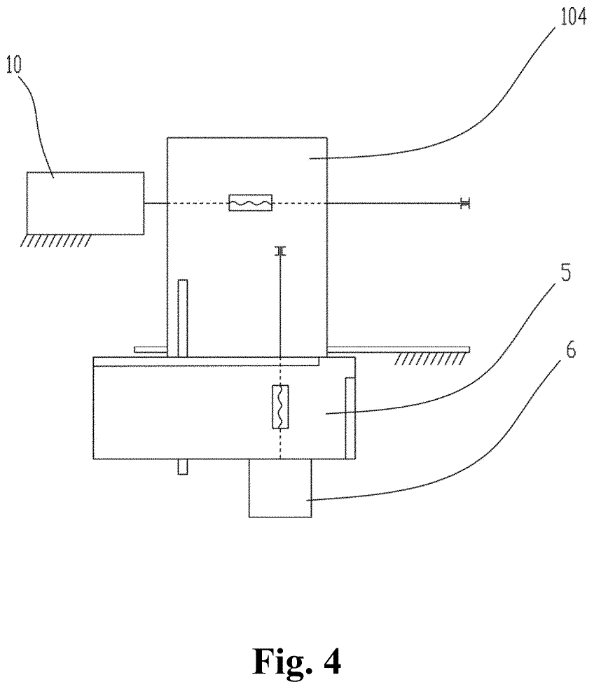

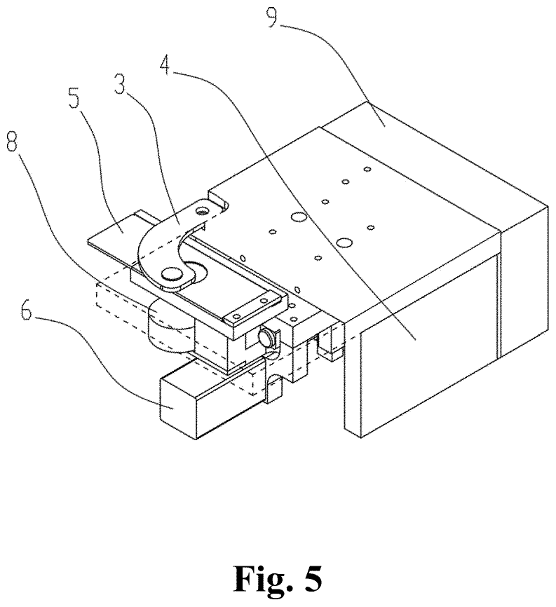

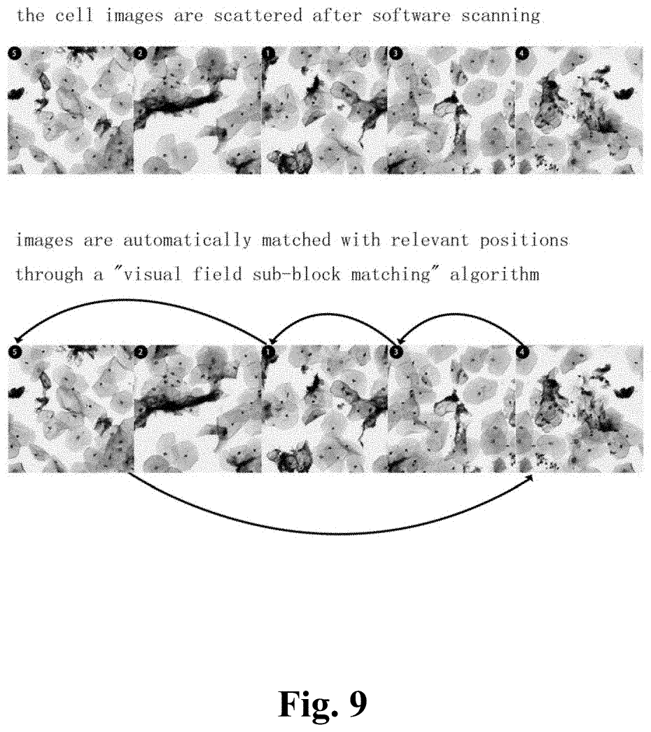

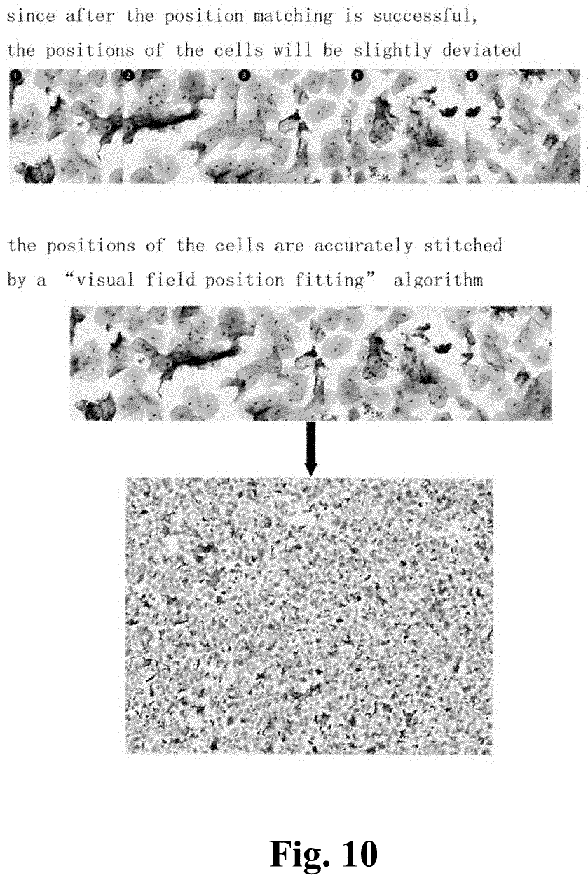

Based on Embodiment 1 and different from Embodiment 1, the preferred solution is shown in FIGS. 4 and 5. The module platform 2 and the support 4 are fixedly connected and kept stationary. The slide holder 5 is connected to the scanning drive module, so that the slide holder 5 makes a scanning movement along the X and Y axes. That is, the solution of this embodiment is a solution in which the module platform 2 is fixed, while the slide holder 5 performs a scanning movement. This solution has the advantages that moving parts can be made in the support 4. What is not as good as the first embodiment is that the structure and control of automatically loading and unloading the slide 7 are relatively complicated. With this structure, a slide image can be conveniently decomposed into a plurality of small images to be photographed, through a serpentine scanning movement of the slide holder 5, and the small images are then stitched into a panoramic image, as shown in FIGS. 9 and 10.

The scanning drive module is structurally characterized in that: the X-axis drive motor 10 is fixedly connected to the support 4; a sliding rail in an X-axis direction is provided on the support 4; a sliding platform 104 is slidably mounted on the slide rail in the X-axis direction; the X-axis drive motor 10 is connected to the sliding platform 104 through a screw and nut mechanism so as to drive the sliding platform 104 to reciprocally slide in the X-axis direction. The sliding platform 104 moves in the X-axis direction to drive the slide holder 5 located thereon to move in the X-axis direction.

The Y-axis drive motor 6 and a sliding rail in a Y-axis direction are fixedly provided on the sliding platform 104; the slide holder 5 is slidably mounted on the sliding rail in the Y-axis direction; the Y-axis drive motor 6 is connected to the slide holder 5 through a screw and nut mechanism so as to drive the slide holder 5 to reciprocally slide in the Y-axis direction.

The miniature microscopic cell image acquisition device is further provided with a control box 9, wherein the control box 9 outputs a switch signal to be connected to the camera module 1 to control the camera module 1 to acquire images; and

the control box 9 outputs pulse signals to be connected to the Y-axis drive motor 6 and the X-axis drive motor 10, respectively, to drive the X-axis drive motor 10 and the Y-axis drive motor 6 to rotate respectively. With this structure, the slider holder 5 makes a serpentine scanning movement.

During use, as shown in FIGS. 1 to 8, a specimen slide is placed on the slide holder 5. Test shooting is performed to adjust the parameters of the camera module 1 according to the sharpness of an image, or adjust the height position of the microscope head 3. After the adjustment is completed, the slide 7 is positioned on the slide holder 5, and a button of the control box 9 is activated, such that the lighting source 8 is turned on. The lighting source 8 may also be set to a normally lighted mode.

This activation method can also be controlled through a touch screen on the control box 9. Parameters are adjusted by the touch screen. Alternatively, the control box 9 is connected with the camera module 1 through Bluetooth or WiFi communication. This activation method can also be controlled through an app interface on the touch screen 113 on the module platform 2. The control box 9 sends a switch signal to the camera module 1, and at the same time the camera module 1 takes a picture and saves the image. The control box 9 sends a pulse signal to the X-axis drive motor 10 to drive the X-axis drive motor 10 to rotate for a preset angle according to the pulse signal, so that the rotation of the X-axis screw rod 101 drives the X-axis drive nut 103 to move a certain distance, and the corresponding X-axis slider 64 moves a certain distance, so that the module platform 2 moves a certain distance along the X axis. The control box 9 sends a switch signal to the camera module 1 and the lighting source 8, the lighting source 8 is turned on, and meanwhile, the camera module 1 takes a picture, wherein the lighting source 8 may also be controlled in a normally lighted mode until the camera module 1 completes a preset stroke along the X axis, thereby completing the photographing of a row of pictures on the slide. The control box 9 sends a pulse signal to the Y-axis drive motor 6 to drive the Y-axis drive motor 6 to rotate for a preset angle, so that the rotation of the Y-axis screw rod 61 drives the Y-axis nut 63 to move a certain distance, the camera module 1 moves a certain distance along the Y axis, and the control box 9 controls the camera module 1 to take a picture. Then, the control box 9 drives the camera module 1 to walk along the X axis again for a preset stroke, and scans the images of the slide 7 into the camera module 1 in a serpentine scanning manner and save the images in the storage chip 92. Next, the pictures are sent to a server through a network, and are stitched into a panoramic image of the slide at the server. The cells in the panoramic image are classified, recognized and identified by an artificial intelligence method, thereby facilitating doctor's diagnosis, completing the acquisition and assistant diagnosis works of the slide images, and greatly improving the doctor's diagnosis efficiency. The processing steps of the pictures can also be partially completed in the control box 9.

### Embodiment 3

In a preferred solution, as shown in FIGS. 9-14, an image stitching process in the miniature microscopic cell image acquisition device is described, in which a visual field sub-block matching module, a visual field position fitting module, and a block extraction module are included, wherein

the visual field sub-block matching module is configured to identify an overlapping area between every two adjacent images and determine an adjacent positional relationship between the sub-images, so that the sub-images acquired by a microscopic scanning device are automatically arranged in a stitching order of the images;

the visual field position fitting module is configured to finely tune positions according to the overlapping area between every two adjacent sub-images, so that cell positions are accurately stitched; and

the block extraction module is configured to automatically extract a completely stitched image.

The specific implementation steps are as follows:

S1: visual field sub-block matching: the visual field sub-block matching module is configured to identify an overlapping region between every two adjacent images and determine an adjacent positional relationship between the sub-images, so that the sub-images acquired by a microscopic scanning device are automatically arranged in a stitching order of the images;

S2: visual field position fitting: the visual field position fitting module is configured to finely tune positions according to the overlapping region between every two adjacent sub-images, so that cell positions are accurately stitched;

S3: block extraction: the block extraction module is configured to automatically extract a completely stitched image.

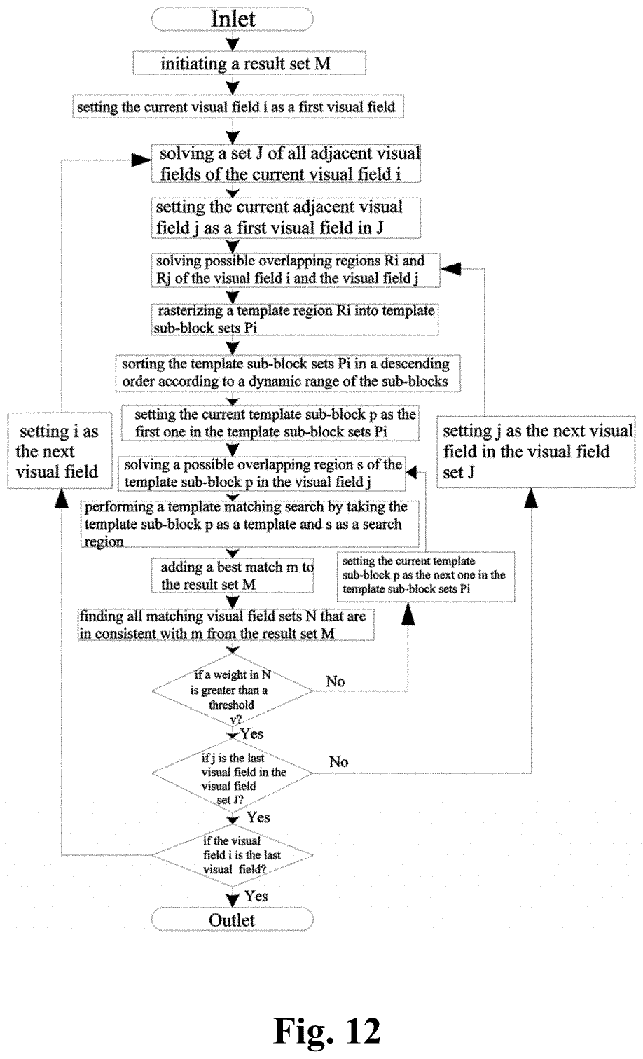

As shown in FIGS. 9 and 12, the operating process of the visual field sub-block matching in step S1 is as follows:

Sa01: inputting and initiating a result set M;

Sa02: setting the current visual field i as a first visual field;

Sa03: solving a set J of all adjacent visual fields of the current visual field i;

Sa04: setting the current adjacent visual field j as a first visual field in J;

Sa05: solving possible overlapping regions Ri and Rj of the visual field i and the visual field j;

Sa06: rasterizing a template region Ri into template sub-block sets Pi;

Sa07: sorting the template sub-block sets Pi in a descending order according to a dynamic range of the sub-blocks;

Sa08: setting the current template sub-block P as the first one in the template sub-block sets Pi;

Sa09: solving a possible overlapping region s of the template sub-block P in the visual field J;

Sa10: performing a template matching search by taking the template sub-block P as a template and s as a search region;

Sa11: adding a best match m to the result set M;

Sa12: finding all matching visual field sets N that are in consistent with m from the result set M;

Sa13: judging whether or not a weight in N is greater than a threshold v upon comparison;

if not, setting the current template sub-block P as the next one in the template sub-block sets Pi and returning to Sa09;

if yes, proceeding to next step;

Sa14: judging whether or not the visual field j is the last visual field in the visual field set J upon comparison;

if not, setting the visual field j as the next visual field in the visual field set J and returning to Sa05;

if yes, proceeding to next step;

Sa15: judging whether or not the visual field i is the last visual field upon comparison;

if not, setting i as the next visual field and returning to Sa03;

if yes, outputting a result;

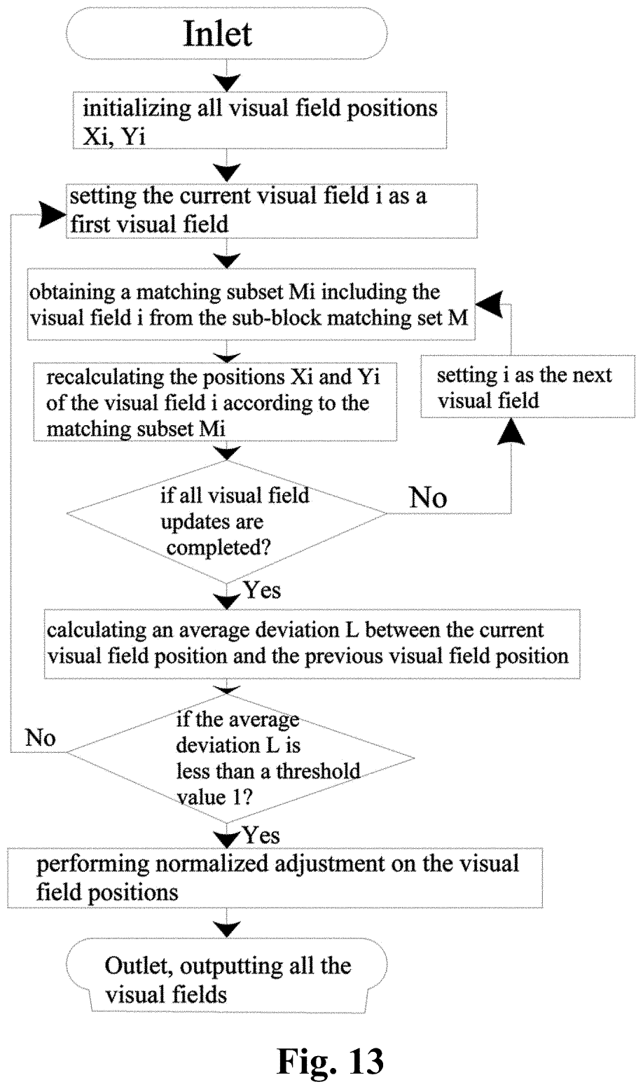

as shown in FIGS. 10 and 13, the process of visual field position fitting in step S2 is as follows:

Sa16: inputting and initializing all visual field positions Xi, Yi;

Sa17: setting the current visual field i as a first visual field;

Sa18: obtaining a matching subset Mi including the visual field i from the sub-block matching set M;

Sa19: recalculating the positions Xi and Yi of the visual field i according to the matching subset Mi;

Sa20: judging whether or not all visual field updates are completed;

if not, setting the visual field i as the next visual field;

if yes, proceeding to next step;

Sa21: calculating an average deviation L between the current visual field position and the previous visual field position;

Sa22: judging whether or not the average deviation L is less than a threshold value 1 upon comparison;

if not, returning to Sa17;

if yes, proceeding to next step;

Sa23: performing normalized adjustment on the visual field positions; outputting all the visual fields;

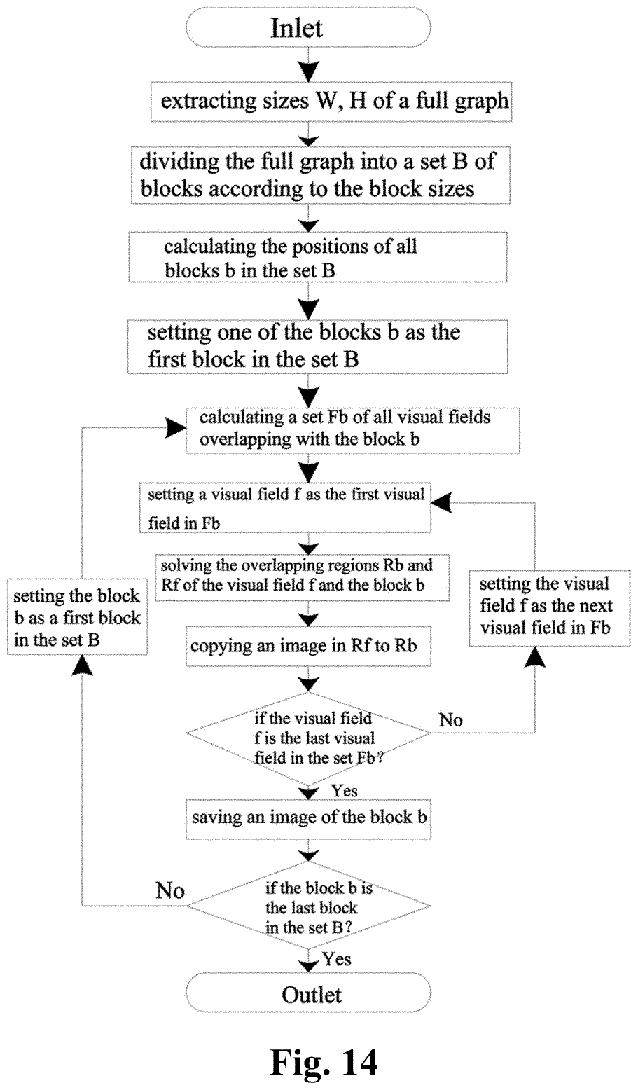

as shown in FIG. 14, the process of block extraction in step S3 is as follows:

Sa24: extracting sizes W, H of a full graph;

Sa25: dividing the full graph into a set B of blocks according to the block sizes;

Sa26: calculating the positions of all blocks b in the set B;

Sa27: setting one of the blocks b as the first block in the set B;

Sa28: calculating a set Fb of all visual fields overlapping with the block b;

Sa29: setting a visual field f as the first visual field in Fb;

Sa30: solving the overlapping regions Rb and Rf of the visual field f and the block b;

Sa31: copying an image in Rf to Rb;

Sa32: judging whether or not the visual field f is the last visual field in the set Fb;

if not, setting the visual field f as the next visual field in Fb and returning to Sa29;

if yes, proceeding to next step;

Sa33: saving an image of the block b;

Sa34: judging whether or not the block b is the last block in the set B;

if not, setting the block b as a first block in the set B and returning to Sa28;

if yes, outputting a result.

### Embodiment 4

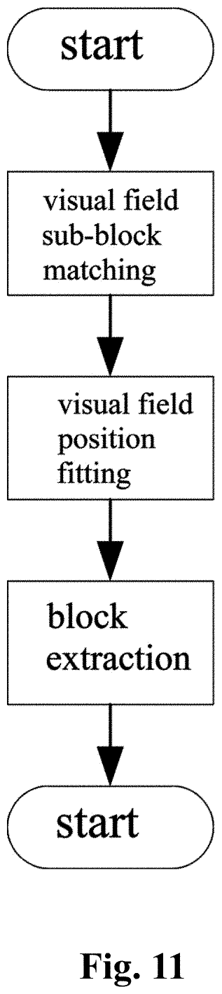

As shown in FIGS. 9-10 and 15-17, a case of a cell pathology analysis is taken as an example: an image acquired from the miniature microscopic cell image acquisition device of the present invention by scanning is shown in the upper image of FIG. 9, and various sub-images are ordered irregularly, which depends on an automatic acquisition path of scanning of the camera module 1. During the acquisition process, it is necessary to ensure that there are mutually overlapping positions between every two of the images. The pixel values of the overlapping positions are analyzed. The images are automatically matched with the corresponding positions by means of a visual field sub-block matching intelligent algorithm. An initial value of a two-dimensional transformation matrix from a platform offset to a pixel offset is calculated according to the matching feature points in the adjacent virtual fields, thereby obtaining stitching parameters. Specifically, each visual field sub-block is determined, that is, the adjacent positions of the sub-image relative to other sub-images are determined. A common part between the adjacent visual fields is cut into a plurality of small blocks, common coincident regions are found by using template matching, and matching blocks with a matching threshold greater than 0.9 are selected. The correlation of template matching for all visual fields is calculated. As shown in FIG. 11, after the position matching is successful, the positions of the cells will be slightly deviated, and the positions of the cells are accurately stitched by a visual field position fitting intelligent algorithm. Specifically, after template matching, the approximate positions of pixels in each visual field can be obtained. The maximum pixel deviation is calculated according to initial stitching parameters and a maximum displacement deviation of the platform. The points where each visual field has a matching relationship with the neighboring visual field are filtered by using the maximum pixel deviation, so as to remove points the deviation of which is greater than the maximum pixel deviation. The stitching parameters are recalculated according to the screened points. The pixel positions of the visual fields are recalculated by using the latest stitching parameters. Through continuous iterative filtering and recalculation, the picture position in each visual field can be continuously updated and improved, so that the error is smaller and the stitching effect is more perfect. After the picture position in each visual field is calculated, the brightness of each visual field is updated through a background image by using a calculation background during the scanning process, thereby improving the doctor's visual perception to view each visual field. A perfect slide picture can be obtained by stitching, and the entire stitched image may be extracted as a block. Then, according to the needs, the big picture is cut to obtain the pictures with the desired widths and heights, because the big picture stitched by all visual fields will be large and unnecessary.

### Embodiment 5

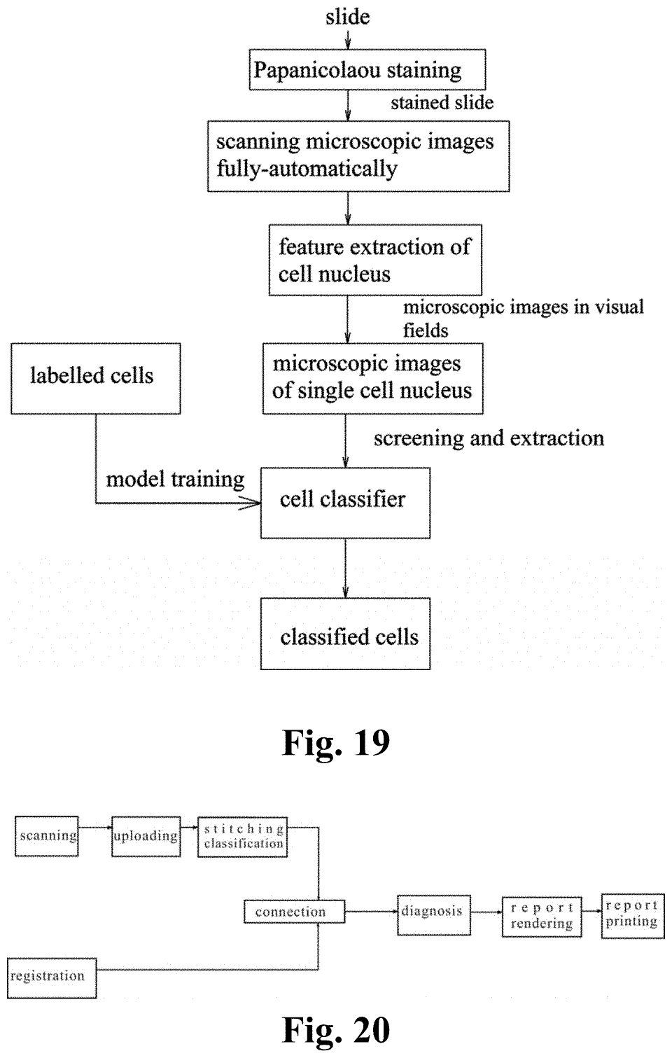

As shown in FIG. 19, an image recognition method adopting the miniature microscopic cell image acquisition device comprises the following implementation steps:

S1: acquiring microscopic images;

S2: stitching a plurality of images of a single sample, and extracting according to cell nucleus features in the stitched image to obtain microscopic images of single cell nucleus;

S3: classifying the microscopic images of single cell nucleus according to the labeled cells by means of an artificial intelligence program subjected to model training, wherein the artificial intelligence program preferably uses a convolutional neural network with a learning rate of 0.001. The number of result categories is num_classes=3, which corresponds to positive, negative, and garbage respectively. The number of training rounds: epochs=300; image size: img_cols=128 img_rows=128; regular parameter: reg=0.7; the number of consecutive declines: patience=10.

The sample-based classified cell data are obtained through the above steps.

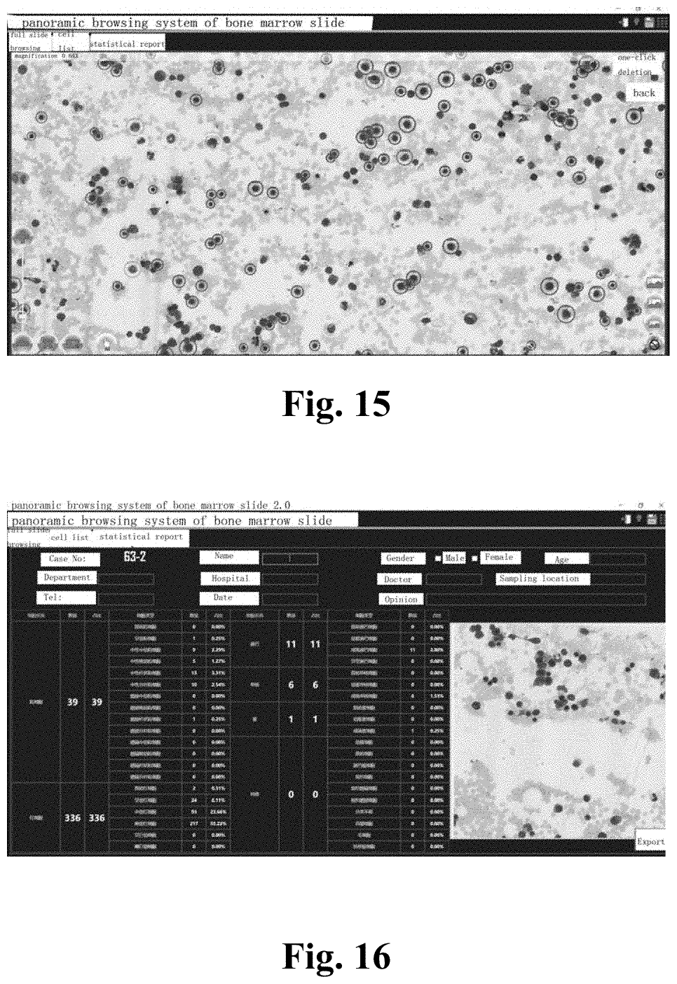

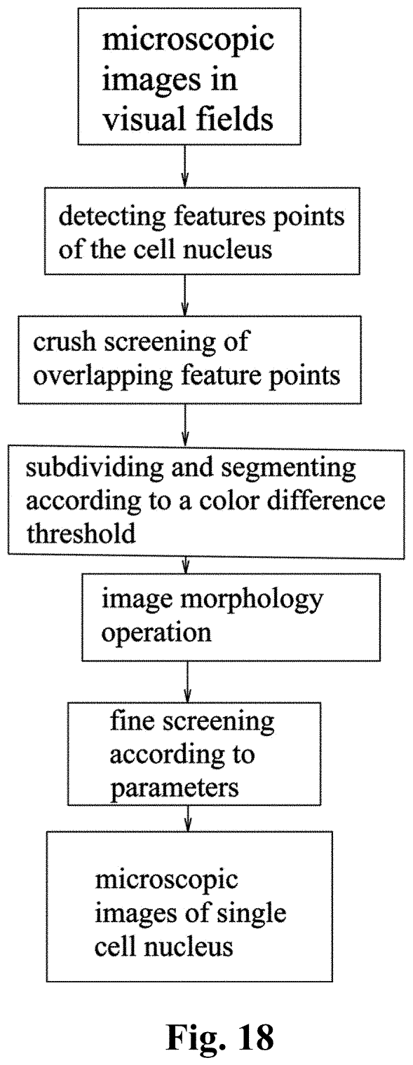

As shown in FIGS. 15 to 18, the step of acquiring the microscopic images of single cell nucleus in step S2 is as follows:

S100: detecting features points of the cell nucleus;

reducing each image to a plurality of different scales and extracting feature points respectively;

S101: performing preliminary screening, i.e., screening to remove feature points that are too close by using coordinates of the feature points, to reduce repeated extraction of cells. Through this step, the efficiency of recognition is greatly improved.

In this embodiment, if the distance between the feature points does not exceed half of the cell's radius, and the half of the radius is greater than 32, it is considered that that the feature points the distance of which is less than 32 pixels are too close, otherwise the feature points the distance of which is less than half of the cell radius are too close. That is cell.Center.L1DistanceTo (d.Center)<Math.Min (cell.Radius*0.5, 32).

S102: subdividing and segmenting according to a color difference threshold: converting a picture to a LAB format; and after the inversion of a B channel as well as the weighting and Otsu thresholding of an A channel, segmenting to obtain a cell nucleus mask map. In the prior art, gray values are used for screening. However, according to the form of gray value, because gray usually has only one channel, and the value range is only 1-255. Therefore, it is difficult to distinguish for some subtle positions. However, the combined solution of B channel and A channel has two channels, which can greatly increase the value range and improve the screening accuracy.

S103: performing image morphology operation: a combination of one or more of corrosion operation and expansion operation. The corrosion calculation and expansion calculation are, for example, calculation methods in the Chinese patent document CN106875404A.

S104: performing fine screening according to a nuclear occupancy parameter to remove non-cells with a nuclear occupancy ratio below 0.3 and a nucleus radius above 150 pixels and below 10 pixels, wherein the nuclear occupancy ratio is obtained by dividing a nuclear area finely segmented according to the color difference threshold by a radius circle area of the detected feature point. The results are shown in FIG. 16. The recognized images of the feature cells of the user are clearly displayed to facilitate the doctor's diagnosis.

### Embodiment 6

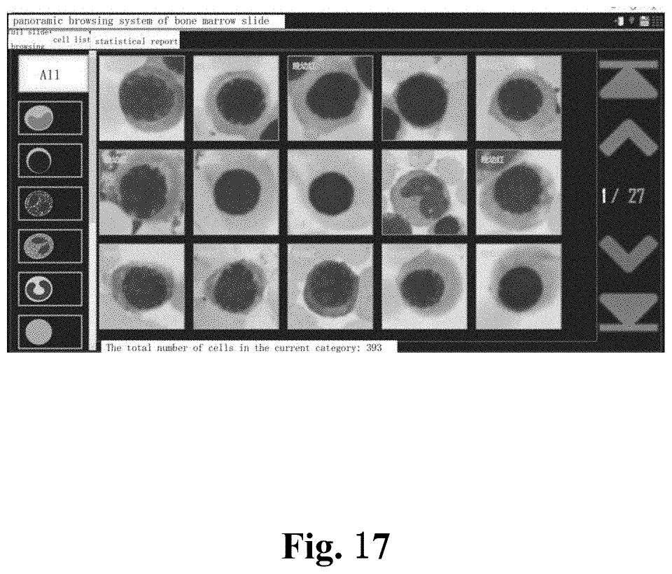

In a preferred solution, as shown in FIG. 16, feature points of a cell nucleus are detected. That is, the feature points of the cell nucleus are detected by a SURF algorithm. The image is reduced to different proportions, and the feature points are extracted respectively. Preliminary screening is performed, i.e., feature points that are too close are removed by screening by using coordinates of the feature points, to reduce repeated extraction of cells, that is, only one of cells with the same feature points remains. Through this step, the efficiency of recognition is greatly improved. Subdividing is performed, i.e., segmenting according to a color difference threshold. Compared with gray-level threshold segmentation, the color-difference threshold segmentation scheme can greatly improve the accuracy of subdivision. As shown in FIG. 9, in the case where cells overlap each other, it can be seen that the color change of the image is greatly different, resulting in easy recognition. When FIG. 10 is converted to grayscale, the difficulty of resolution is greatly increased. Image morphology operation is performed, wherein a combination of one or more of corrosion operation and expansion operation is used; and the corrosion calculation and expansion calculation are, for example, calculation methods in the Chinese patent document CN106875404A. The erosion operation refers to corroding to remove the edges of the image, and aims to remove “burrs” on the edges of a target. The expansion operation refers to expanding the edges of the image, and aims to fill the edges or internal pits of the target image. The target image is made to be smoother by using the same number of times of corrosion and expansion. The results are shown in FIG. 17. Fine screening is performed according to the nuclear occupancy parameter to remove non-cells with a nuclear occupancy ratio below 0.3 and a nucleus radius above 150 pixels and below 10 pixels, wherein the nuclear occupancy ratio is obtained by dividing a nuclear area finely segmented according to the color difference threshold by a radius circle area of the detected feature point. The results are shown in FIG. 17, and the recognized images of each feature cell of the user are clearly displayed in a list, preferably, and are arranged in a positive-negative order to facilitate the doctor's diagnosis and assist the doctor to improve the diagnosis efficiency. Further preferably, during the operation, the coordinates of diagonal points of the resulting feature cell image are retained. For example, during the operation process, a coordinate operation record is retained in a form of a log, and the coordinate position of the feature cell image on the stitched image is retained so that the doctor can quickly browse the original image according to the coordinate position. Further preferably, unprocessed original sub-images can be quickly browsed according to the correspondence between the coordinates and the sub-images to prevent important cytopathological image features from being erased by intelligent operations and further determine the diagnostic accuracy.

### Embodiment 7

In a preferred solution, as shown in FIG. 20, a method for cloud processing of an image, that adopts the miniature microscopic cell image acquisition device comprises the following implementation steps:

S1: numbering: numbering samples on the slide 7 to determine sample numbers in a cloud system. Samples of the slide 7 are acquired before the process on the cloud starts. After a batch of samples are acquired uniformly, they will be renumbered to determine the correspondence between the samples of the slide 7 and the information of a subject.

S2: registration: entering subject information corresponding to the slide 7 into the system and entering the sample number; and scanning: scanning images of the slide 7 with the camera module 11 to digitalize the samples. Registration and scanning are performed at the same time without interference. In the course of registering, the information of the subject is entered into the system, and the renumbered sample number is entered.

S3: uploading: uploading the scanned image samples to the cloud system. The cloud system provides a network-based data access service, which can store and recall various unstructured data files including text, pictures, audio, and video at any time through the network. Alibaba Cloud OSS uploads data files into a bucket in a form of objects, with rich SDK packages, and adapts to different computer languages for secondary development.

S4: stitching classification: processing the digital samples on cloud AI. The cloud AI performs a preliminary diagnosis on the digitized samples of the subject, and the sample of the subject at risk of disease is passed to step S6 for further diagnosis by the doctor.

S5: connection: associating the registration information with the digitalized sample information in the system. Associating the personal information of the subject with the sample information of the subject is convenient for returning an inspection report to the subject at the later stage, which is beneficial to the later collation and further research of the data at the same time.

S6: diagnosis: diagnosing and reviewing the image samples, and submitting a diagnosis opinion operation by a doctor. The subject who may have a risk of disease in the preliminary diagnosis by AI is diagnosed and reviewed by the doctor, which improves the accuracy of the diagnosis but greatly reduces the cost of diagnosis. The sampling mechanism completes the acquisition of cell specimen image information, and then passes the data to a cloud diagnosis platform via the Internet. The artificial intelligence will automatically complete the diagnosis, and the doctor only needs to review and confirm the results that are positive. Because positive cases are often in the minority, artificial intelligence cloud diagnosis can save a lot of manual labor.

S7: report rendering: polling the completely diagnosed data in the system by using a rendering program and rendering the data into PDF, JPG, WORD format files according to corresponding report templates thereof. The rendering program is used to render a web page according to the required report template, extract the required fields, call PDF, JPG, and WORD components, and generate PDF, JPG, and WORD format files. Reports may also be printed. The corresponding programs can be connected to a printer to print the reports in batches. The hospital can call a local printer driver through a system web interface, and print the reports in batches as needed. At the same time, the system can return an electronic report to the subject through the entered information.

Cloud processing of the images is achieved by the above steps.

The above embodiments are merely preferred technical solutions of the present invention and should not be construed as limiting the present invention. The embodiments and the features in the embodiments in the present application may be arbitrarily combined without conflicting with each other. The protection scope of the present invention should be subjected to the technical solution of claims, including equivalent replacement solutions of the technical features of the technical solutions described in the claims. That is, equivalent replacement improvements within this range are also included in the scope protection of the present invention.

1. A miniature microscopic cell image acquisition device, comprising a support (4), wherein
a movable module platform (2) is provided on the support (4), and a camera module (1) is provided on the module platform (2);
a microscope head (3) that is relatively fixed is provided below a camera (111) of the camera module (1), a slide holder (5) is provided below the microscope head (3), and a lighting source (8) is provided below the slide holder (5); and
a scanning drive module is provided between the slide holder (5) and the camera module (1) to perform a scanning movement along X axis and Y axis, so that the slide holder (5) and the camera module (1) make a scanning movement along the X axis and Y axis, and images of a slide (7) are collected by the camera module (1) in a scanning manner.

2. The miniature microscopic cell image acquisition device according to claim 1, wherein,
the microscope head (3) comprises a cantilever rod (32) mounted on the module platform (2), one end of the cantilever rod (32) is fixedly connected to the module platform (2), and a microscope lens is provided on the other end of the cantilever rod;
the microphone lens is located below a camera (111); and a magnification of the microscope lens is 2 to 10 times.

3. The miniature microscopic cell image acquisition device according to claim 2, wherein,
the module platform (2) is provided with a sunken stage (21) near the camera (111), and the cantilever rod (32) is slidably connected to the stage (21) through a plurality of positioning screws (22);
an adjusting screw (23) is in threaded connection with the cantilever rod (32);
a tip of the adjusting screw (23) props against the stage (21);
a distance between the cantilever rod (32) and the stage (21) is adjusted by a rotation of the adjusting screw (23); and
the microscope lens is a replaceable microscope lens (31).

4. The miniature microscopic cell image acquisition device according to claim 1, further comprising a control box (9), wherein
a main control chip (91) is provided in the control box (9) and electrically connected with the camera (111);
the main control chip (91) is further electrically connected with a control button (112) and/or a touch screen (113) of the camera module (1);
the main control chip (91) is further electrically connected with a drive motor of the scanning drive module; and
the camera (111) adopts a mobile phone camera accessory.

5. The miniature microscopic cell image acquisition device according to claim 4, wherein,
the module platform (2) is connected to the scanning drive module, such that the camera (111) makes a scanning movement along the X axis and Y axis;
the slide holder (5) and the support (4) are fixedly connected and kept stationary;
a structure of the scanning drive module is as follows:
an X-axis guide rail (102) is fixedly provided on the support (4), and an X-axis slider (64) is slidably mounted on the X-axis guide rail (102); an X-axis nut (103) is fixedly provided on the X-axis slider (64); an X-axis screw rod (101) is rotatably mounted on the support (4); the X-axis nut (103) is in threaded connection with the X-axis screw rod (101); an X-axis drive motor (10) is fixedly provided on the support (4); an output shaft of the X-axis drive motor (10) is fixedly connected to the X-axis screw rod (101), so that the X-axis drive motor (10) drives the X-axis slider (64) to reciprocate along the X-axis guide rail (102);
a Y-axis guide rail (62) is fixedly provided on the X-axis slider (64), and the module platform (2) is slidably mounted on the Y-axis guide rail (62); a Y-axis nut (63) is fixedly provided on the module platform (2); a Y-axis screw rod (61) is rotatably mounted on the X-axis slider (64); a Y-axis nut (63) is in threaded connection with the Y-axis screw rod (61); a Y-axis drive motor (6) is fixedly provided on the X-axis slider (64); an output shaft of the Y-axis drive motor (6) is fixedly connected to the Y-axis screw rod (61), so that the Y-axis drive motor (6) drives the module platform (2) to reciprocate along the Y-axis guide rail (62);
the miniature microscopic cell image acquisition device is further provided with a control box (9), wherein the control box (9) outputs a switch signal to be connected to the camera module (1) to control the camera module (1) to take pictures; and
the control box (9) outputs pulse signals to be connected to the Y-axis drive motor (6) and the X-axis drive motor (10), respectively, to drive the X-axis drive motor (10) and the Y-axis drive motor (6) to rotate respectively.

6. The miniature microscopic cell image acquisition device according to claim 4, wherein,
the module platform (2) and the support (4) are fixedly connected and kept stationary; the slide holder (5) is connected to the scanning drive module, so that the slide holder (5) makes a scanning movement along the X axis and Y axis;
a structure of the scanning drive module is as follows:
the X-axis drive motor (10) is fixedly connected to the support (4); a sliding rail in an X-axis direction is provided on the support (4); a sliding platform (104) is slidably mounted on the slide rail in the X-axis direction; the X-axis drive motor (10) is connected to the sliding platform (104) through a screw and nut mechanism so as to drive the sliding platform (104) to reciprocally slide in the X-axis direction;
the Y-axis drive motor (6) and a sliding rail in a Y-axis direction are fixedly provided on the sliding platform (104); the slide holder (5) is slidably mounted on the sliding rail in the Y-axis direction; the Y-axis drive motor (6) is connected to the slide holder (5) through a screw and nut mechanism so as to drive the slide holder (5) to reciprocally slide in the Y-axis direction;
the miniature microscopic cell image acquisition device is further provided with a control box (9), wherein the control box (9) outputs a switch signal to be connected to the camera module (1) to control the camera module (1) to take pictures; and
the control box (9) outputs pulse signals to be connected to the Y-axis drive motor (6) and the X-axis drive motor (10), respectively, to drive the X-axis drive motor (10) and the Y-axis drive motor (6) to rotate respectively.

7. The miniature microscopic cell image acquisition device according to claim 5, wherein,
the Y-axis drive motor (6) and the Y-axis drive motor (6) are stepping motors;
a storage chip (92), an interface chip (93) and a wireless transmission chip (95) are further provided in the control box (9), and are all electrically connected with the main control chip (91);
the storage chip (92) is configured to store data, and the interface chip (93) and the wireless transmission chip (95) are configured to transmit data; and
the control box (9) is further provided with a power chip (94) configured to supply power to the main control chip (91), the storage chip (92), the interface chip (93) and the wireless transmission chip (95).

8. An image stitching method adopting the miniature microscopic cell image acquisition device according to claim 1, wherein the miniature microscopic cell image acquisition device comprises a visual field sub-block matching module, a visual field position fitting module, and a block extraction module, wherein
the visual field sub-block matching module is configured to identify an overlapping area between every two adjacent images and determine an adjacent positional relationship between the sub-images, so that the sub-images acquired by a microscopic scanning device are automatically arranged in a stitching order of the images;
the visual field position fitting module is configured to finely tune positions according to the overlapping area between every two adjacent sub-images, so that cell positions are accurately stitched;
the block extraction module is configured to automatically extract a completely stitched image; and
the specific implementation steps are as follows:
S1 visual field sub-block matching: the visual field sub-block matching module is configured to identify an overlapping region between every two adjacent images and determine an adjacent positional relationship between the sub-images, so that the sub-images acquired by the microscopic scanning device are automatically arranged in a stitching order of the images;
S2 visual field position fitting: the visual field position fitting module is configured to finely tune positions according to the overlapping region between every two adjacent sub-images, so that cell positions are accurately stitched;
S3 block extraction: the block extraction module is configured to automatically extract a completely stitched image;
the operating process of the visual field sub-block matching in step S1 is as follows:
Sa01: inputting and initiating a result set M;
Sa02: setting a current visual field i as a first visual field;
Sa03: solving a set J of all adjacent visual fields of the current visual field i;
Sa04: setting a current adjacent visual field j as a first visual field in J;
Sa05: solving possible overlapping regions Ri and Rj of the visual field i and the visual field j;
Sa06: rasterizing a template region Ri into template sub-block sets Pi;
Sa07: sorting the template sub-block sets Pi in a descending order according to a dynamic range of the sub-blocks;
Sa08: setting a current template sub-block P as a first one in the template sub-block sets Pi;
Sa09: solving a possible overlapping region s of the template sub-block P in the visual field J;
Sa10: performing a template matching search by taking the template sub-block P as a template and s as a search region;
Sa11: adding a best match m to the result set M;
Sa12: finding all matching visual field sets N that are in consistent with m from the result set M;
Sa13: judging whether or not a weight in N is greater than a threshold v upon comparison;
if not, setting the current template sub-block P as the next one in the template sub-block sets Pi and returning to Sa09;
if yes, proceeding to next step;
Sa14: judging whether or not the visual field j is the last visual field in the visual field set J upon comparison;
if not, setting the visual field j as the next visual field in the visual field set J and returning to Sa05;
if yes, proceeding to next step;
Sa15: judging whether or not the visual field i is the last visual field upon comparison;
if not, setting i as the next visual field and returning to Sa03;
if yes, outputting a result;
the process of visual field position fitting in step S2 is as follows:
Sa16: inputting and initializing all visual field positions Xi, Yi;
Sa17: setting the current visual field i as a first visual field;
Sa18: obtaining a matching subset Mi including the visual field i from the sub-block matching set M;
Sa19: recalculating the positions Xi and Yi of the visual field i according to the matching subset Mi;
Sa20: judging whether or not all visual field updates are completed;
if not, setting the visual field i as the next visual field;
if yes, proceeding to next step;
Sa21: calculating an average deviation L between the current visual field position and the previous visual field position;
Sa22: judging whether or not the average deviation L is less than a threshold value 1 upon comparison;
if not, returning to Sa17;
if yes, proceeding to next step;
Sa23: performing normalized adjustment on the visual field positions;
outputting all the visual fields;
the process of block extraction in step S3 is as follows:
Sa24: extracting sizes W, H of a full graph;
Sa25: dividing the full graph into a set B of blocks according to the block sizes;
Sa26: calculating the positions of all blocks b in the set B;
Sa27: setting one of the blocks b as the first block in the set B;
Sa28: calculating a set Fb of all visual fields overlapping with the block b;
Sa29: setting a visual field f as the first visual field in Fb;
Sa30: solving the overlapping regions Rb and Rf of the visual field f and the block b;
Sa31: copying an image in Rf to Rb;
Sa32: judging whether or not the visual field f is the last visual field in the set Fb;
if not, setting the visual field f as the next visual field in Fb and returning to Sa29;
if yes, proceeding to next step;
Sa33: saving an image of the block b;
Sa34: judging whether or not the block b is the last block in the set B;
if not, setting the block b as a first block in the set B and returning to Sa28; and
if yes, outputting a result.

9. An image recognition method adopting the miniature microscopic cell image acquisition device according to claim 1, comprising the following steps:
S1: acquiring microscopic images;
S2: stitching a plurality of images of a single sample, and extracting according to cell nucleus features in the stitched image to obtain microscopic images of single cell nucleus;
S3: classifying the microscopic images of single cell nucleus according to the labeled cells by means of an artificial intelligence program subjected to model training;
thereby obtaining sample-based classified cell data through the above steps;
the step of acquiring the microscopic image of single cell nucleus in step S2 is as follows:
S100: detecting features points of the cell nucleus:
reducing each image to a plurality of different scales and extracting feature points respectively;
S101: performing preliminary screening, i.e., screening to remove feature points that are too close by using coordinates of the feature points, thereby reducing repeated extraction of cells;
S102: subdividing and segmenting according to a color difference threshold:
converting a picture to a LAB format; and after the inversion of a B channel as well as the weighting and Otsu thresholding of an A channel, segmenting to obtain a cell nucleus mask map, wherein
the weight is 0.7 for the B channel under the inversion and 0.3 for the A channel;
S103: performing image morphology operation:
a combination of one or more of corrosion operation and expansion operation; and
S104; performing fine screening according to a nuclear occupancy parameter to remove non-cells each having a nuclear occupancy ratio below 0.3 and a nucleus radius above 150 pixels and below 10 pixels, wherein the nuclear occupancy ratio is obtained by dividing a nuclear area finely segmented according to the color difference threshold by a radius circle area of the detected feature point.

10. A method for cloud processing of an image, that adopts the miniature microscopic cell image acquisition device according to claim 1, comprising the following steps:
S1: numbering: numbering samples on the slide (7) to determine sample numbers in a cloud system;
S2: registration: entering subject information corresponding to the slide (7) into the system and entering the sample numbers;
scanning: scanning images of the slide (7) with the mobile phone (11);
S3: uploading: uploading the scanned image samples to the cloud system;
S4: stitching classification: processing the digital samples on cloud AI;
S5: connection: associating the registration information with the digital sample information in the system;
S6: diagnosis: diagnosing and reviewing the image samples, and submitting a diagnosis opinion operation by a doctor;
S7: report rendering: polling the completely diagnosed data in the system by using a rendering program and rendering the data into PDF, JPG, WORD format files according to corresponding report templates thereof;
thereby achieving cloud processing of the images through the above steps.

11. The miniature microscopic cell image acquisition device according to claim 6, wherein,
the Y-axis drive motor (6) and the Y-axis drive motor (6) are stepping motors;
a storage chip (92), an interface chip (93) and a wireless transmission chip (95) are further provided in the control box (9), and are all electrically connected with the main control chip (91);
the storage chip (92) is configured to store data, and the interface chip (93) and the wireless transmission chip (95) are configured to transmit data; and
the control box (9) is further provided with a power chip (94) configured to supply power to the main control chip (91), the storage chip (92), the interface chip (93) and the wireless transmission chip (95).
